(19) United States
(12) Patent Application Publication
(10) Pub. No.: US 2006/0265884 A1
(43) Pub. Date: Nov. 30, 2006

(54) Bayonet having a serrated edge and a balanced positioning access point

(76) Inventor: Nicholas D. Trbovich JR., Orchard Park, NY (US)

Correspondence Address: JAECKLE FLEISCHMANN & MUGEL, LLP, 190 Linden Oaks, ROCHESTER, NY, 14625-2812, US

(21) Appl. No.: 11/343,834

(22) Filed: Jan. 31, 2006

Related U.S. Application Data
(63) Continuation-in-part of application No. 10/865,126, filed on Jun. 10, 2004.
(60) Provisional application No. 60/478,140, filed on Jun. 12, 2003.

(51) Int. Cl. B26B 29/00

(52) U.S. Cl. 30/296.1; 30/295; 30/340

(57) ABSTRACT

A bayonet is provided which comprises: a blade having a sharpened portion and a tang integral with the sharpened portion; a handle enclosing the tang of said blade, said handle having a first end proximate to the sharpened portion of said blade and a second end proximate to an end of the tang of said blade; a guard between the sharpened portion of said blade and the first end of said handle; a clip affixed to the second end of said handle, said clip being further affixed to the end of the tang of said blade; and a positioning access point on said handle proximate to the second end of said handle. A bayonet is further provided which comprises: a blade having a sharpened portion and a tang integral with the sharpened portion, the sharpened portion including a lower sharpened edge which is serrated; a handle enclosing the tang of said blade, said handle having a first end proximate to the sharpened portion of said blade and a second end proximate to an end of the tang of said blade; a guard between the sharpened portion of said blade and the first end of said handle; and a clip affixed to the second end of said handle, said clip being further affixed to the end of the tang of said blade.

### CROSS-REFERENCE TO RELATED APPLICATIONS

This application is a continuation-in-part of prior U.S. application Ser. No. 10/865,126 filed on Jun. 10, 2004, pending, which claims priority of U.S. Provisional Patent Application Ser. No. 60/478,140, filed Jun. 12, 2003.

### STATEMENT REGARDING FEDERALLY SPONSORED RESEARCH OR DEVELOPMENT

Not applicable.

### BACKGROUND OF THE INVENTION

Serrated portions of the sharpened edge of knives are common for enhancing the ability of the knife to cut certain materials such as rope and aircraft aluminum. The Geneva Convention prohibits use of bayonets having a serrated top edge; however bayonets having a serrated bottom edge or a partially serrated bottom edge is desired.

Further, a user of a bayonet often needs to rapidly reorient the bayonet. However, such reorientation makes it easy for the user to loose his/her grip on the handle of conventional bayonets. Therefore a bayonet having a positioning access point is desired in the art.

### BRIEF SUMMARY OF THE INVENTION

A bayonet is provided which comprises: a blade having a sharpened portion and a tang integral with the sharpened portion; a handle enclosing the tang of said blade, said handle having a first end proximate to the sharpened portion of said blade and a second end proximate to an end of the tang of said blade; a guard between the sharpened portion of said blade and the first end of said handle; a clip affixed to the second end of said handle, said clip being further affixed to the end of the tang of said blade; and a positioning access point on said handle proximate to the second end of said handle.

A bayonet is further provided which comprises: a blade having a sharpened portion and a tang integral with the sharpened portion, the sharpened portion including a lower sharpened edge which is serrated; a handle enclosing the tang of said blade, said handle having a first end proximate to the sharpened portion of said blade and a second end proximate to an end of the tang of said blade; a guard between the sharpened portion of said blade and the first end of said handle; and a clip affixed to the second end of said handle, said clip being further affixed to the end of the tang of said blade.

### BRIEF DESCRIPTION OF THE SEVERAL VIEWS OF THE DRAWINGS

The above-mentioned and other features and advantages of this invention, and the manner of attaining them, will become appreciated and be more readily understood by reference to the following detailed description of the embodiments of the invention in conjunction with the accompanying drawings, wherein:

FIG. 1 is a side view of the bayonet of the present invention;

FIG. 2 is a side view of the blade of FIG. 1;

FIG. 3 is an opposite side view of the bayonet of FIG. 1;

FIG. 4 is a top view of the bayonet of FIG. 1;

FIG. 5 is an end view of the bayonet of FIG. 1;

FIG. 6 is a side view of the bayonet of the present invention having an alternate blade shape;

FIG. 7 is side view of the bayonet of the present invention having a further alternate blade shape;

FIG. 8 is a side view of the bayonet of the present invention having an alternate blade shape; and

FIG. 9 is a top plan view of FIG. 8.

Corresponding reference characters indicate corresponding parts throughout the several views. The exemplifications set out herein illustrate the preferred embodiments of the invention and such exemplifications are not to be construed as limiting the scope of the invention in any manner.

### DETAILED DESCRIPTION OF THE INVENTION

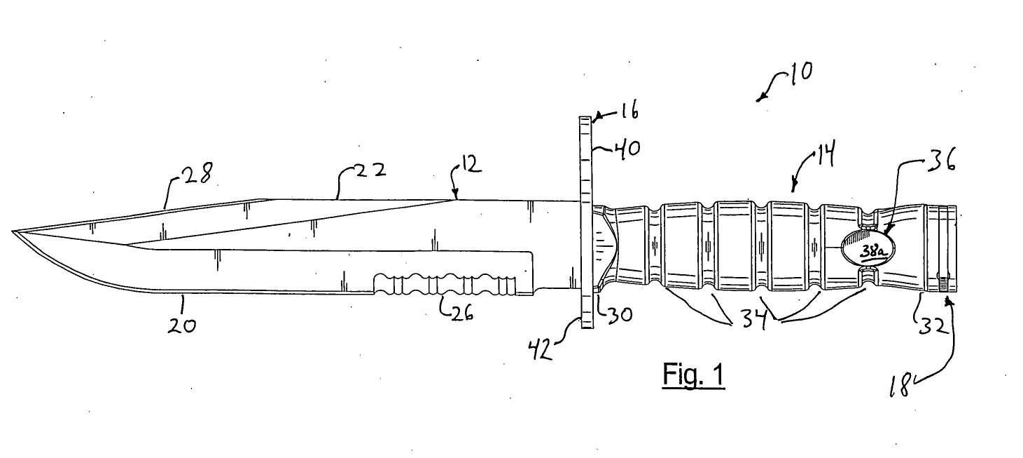

Referring to FIG. 1, there is shown the bayonet of the present invention. The bayonet 10 includes a blade 12, a handle 14, a guard 16, and a clip 18.

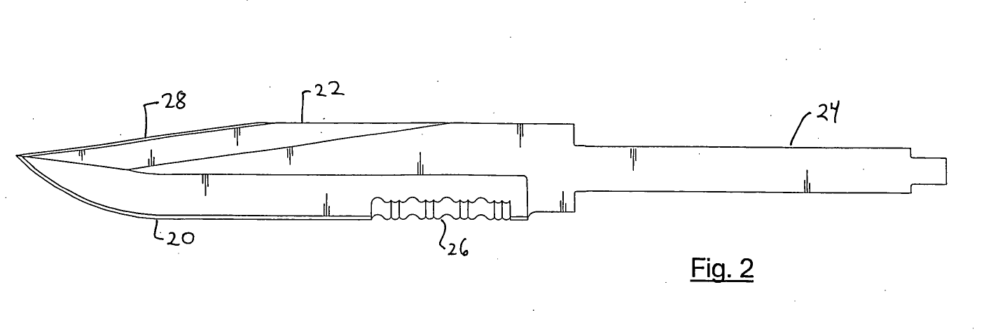

Referring to FIGS. 1 and 2, the blade 12 includes a bottom edge 20, a top edge 22, and a tang 24. The bottom edge 20 is sharpened along its length and includes a serrated portion 26. The serrated portion 26 improves the ability of the bayonet to cut through materials such as rope and aircraft grade aluminum. The top edge 22 includes a sharpened portion 28.

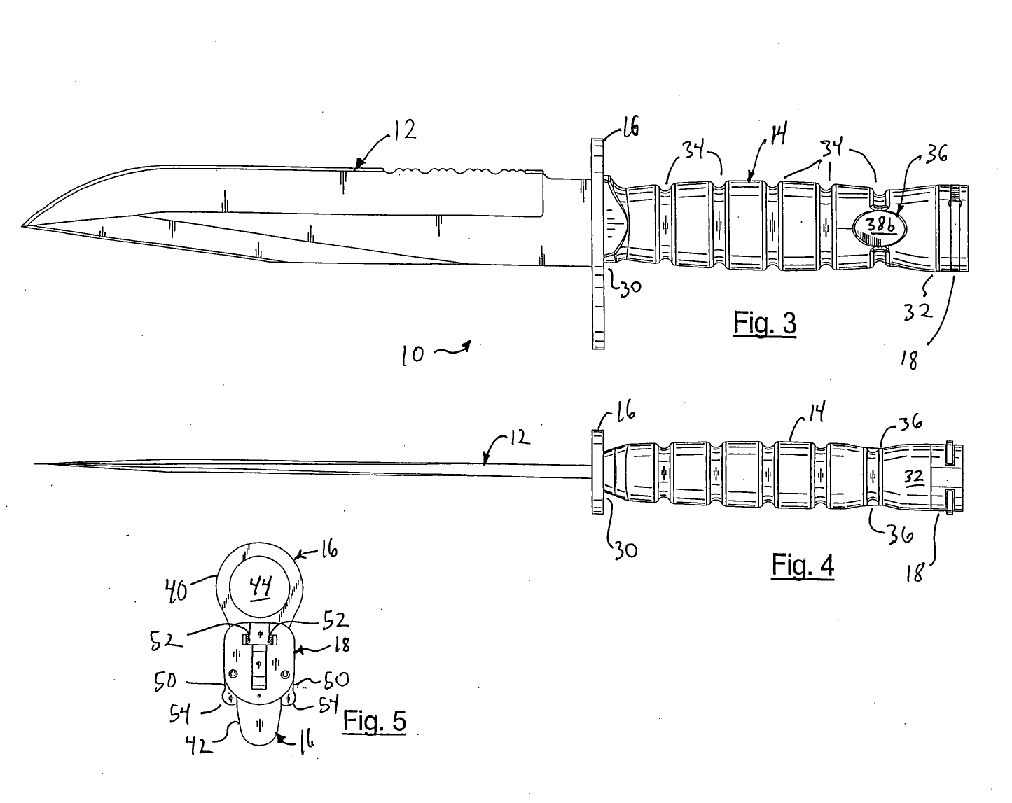

Referring now to FIGS. 1 and 3, the handle 14 includes a first end 30, a second end 32, grooves 34, and a positioning access point 36. Grooves 34 improve the grip of the handle 14 and reduce the weight of the handle 14. The positioning access point 36 is located proximate to the second end 32 and is marked by recessed logos 38a and 38b on either side of handle 14. As shown in FIG. 4, the positioning access point 36 comprises an indented portion of the handle 14. Further, the positioning access point 36 is located at a natural pivot point of the bayonet 10. Thus, when the index finger or the middle finger and the thumb are placed on opposing sides of the positioning access point 36, the bayonet 10 pivots naturally about the positioning access point 36 between the finger and the thumb.

Referring to FIGS. 1 and 5, the guard 16 includes a top portion 40 and a bottom portion 42. The top portion 40 is proximate to the top edge 22 of the blade 12 and extends above the handle 14. The top portion 40 further includes a bore 44 having a clearance fit with a rifle barrel. The bottom portion 42 extends below the handle 14. Thus top portion 40 and bottom portion 42 prevent the user's hand from slipping onto the blade 12 during use.

The clip 18 is a quick-disconnect attachment for affixing the bayonet 10 to a rifle. The clip 18 includes levers 50 having a hook end 52 and a finger grip end 54. The levers 50 pivot about a fulcrum between the finger grip end 54 and the hook end 52 when the finger grip ends 54 are compressed thereby releasing the clip 18. The clip 18 is affixed to the second end 32 of the handle 14 by rivets, screws, epoxy, or other suitable fastening means. The tang 24 is affixed to the clip 18 by welding, epoxy, or other suitable fastening means. The tang 24 is preferably peened and placed in tension between the guard 16 and the clip 18. Thus, the handle 14 is placed under a compressive force via the first end 30 and the second end 32.

In use, the bayonet 10 often must be reoriented. For example, the bayonet 10 is often removed from a scabbard in the upright position but must be attached to a rifle in the inverted position. Therefore, it would be an advantage to be able to quickly invert the bayonet 10. Because the positioning access point 36 is indented and marked by recessed logos 38a and b, the index finger (or middle finger) and thumb naturally slide along the bayonet 10 from the first end 30 to the positioning access point 36. Once the finger and thumb are in opposing positions on the positioning access point 36, the bayonet 10 pivots quickly and easily from the upright position to the inverted position. Rapid reorientation of the bayonet 10 is also often required in combat.

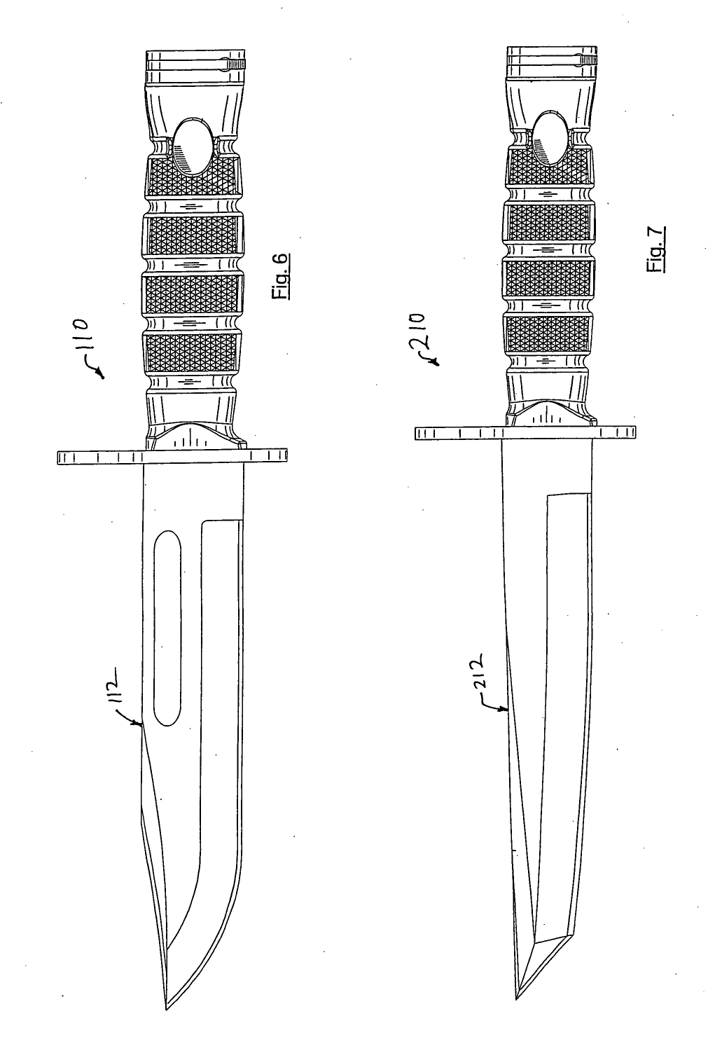

Although the handle 14 is shown in the drawings having a double belly design, a single belly design may also be used. The material of the handle 14 is preferably DYNAFLEX G7980™ however any material having suitable strength may be used. DYNAFLEX G7980™ is a trademark of GLS Corporation and is a thermoplastic elastomer compound made with KRATON® Polymer. KRATON® is a registered Trademark of KRATON Polymers U.S. LLC. KRATON® polymers and compounds may contain combinations of styrene-butadiene-styrene, styrene-isoprene-styrene, styrene-ethylene/butylene-styrene, and styrene-ethylene/propylene. The handle 14 may be textured to improve the user's grip. The texturing may be diamond texturing as shown in FIGS. 6 and 7 or the handle 14 may be otherwise suitably knurled.

As shown in FIGS. 6 and 7, bayonets 110 and 210 have alternately shaped blades 112 and 212, respectively. The alternately shaped blades 112 and 212 may also include serrations.

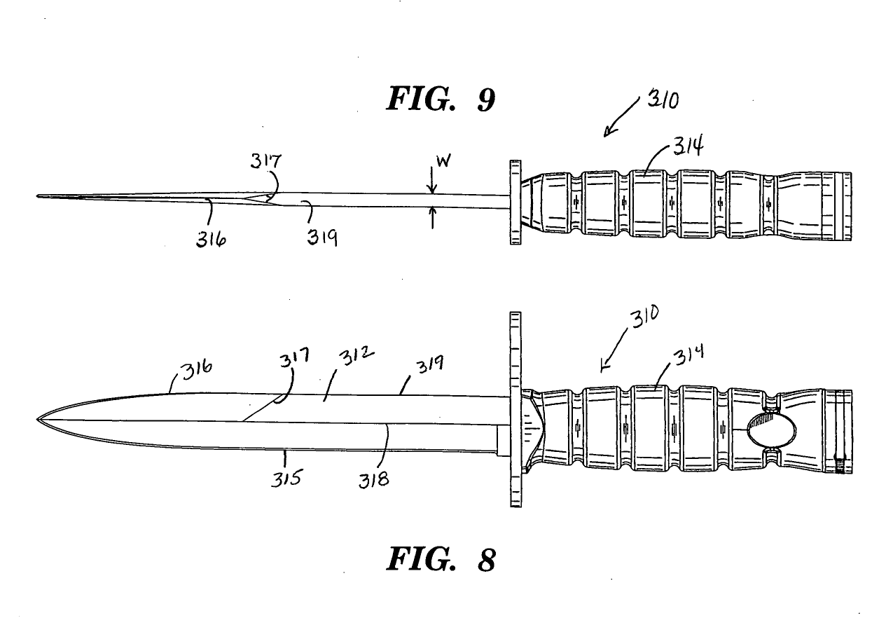

As shown in FIGS. 8 and 9, bayonet 310 has an alternately shaped blade 312 having lower and upper sharpened edges 315, 316, respectively. Blade 312 is of substantially constant width “w” from the handle 314 to the blade end 317. A taper line 317 extends diagonally rearward from the blade midline 318 to the top edge 319 of blade 312. It is understood that all or any combination of the features of bayonet 10 described above may be incorporated into bayonet 310 as well.

1. A bayonet comprising:
a blade having a sharpened portion and a tang integral with the sharpened portion;
a handle enclosing the tang of said blade, said handle having a first end proximate to the sharpened portion of said blade and a second end proximate to an end of the tang of said blade;
a guard between the sharpened portion of said blade and the first end of said handle;
a clip affixed to the second end of said handle, said clip being further affixed to the end of the tang of said blade; and
a positioning access point on said handle proximate to the second end of said handle.

2. The bayonet according to claim 1, wherein said positioning access point includes a recessed logo.

3. The bayonet according to claim 1, wherein said positioning access point is an indented portion of said handle.

4. The bayonet according to claim 3, wherein said positioning access point is indented on two opposing sides of the positioning access point.

5. The bayonet according to claim 4, wherein said positioning access point includes a recessed logo on each of the two indented sides of said positioning access point.

6. A bayonet comprising:
a blade having a sharpened portion and a tang integral with the sharpened portion, the sharpened portion including a lower sharpened edge which is serrated;
a handle enclosing the tang of said blade, said handle having a first end proximate to the sharpened portion of said blade and a second end proximate to an end of the tang of said blade;
a guard between the sharpened portion of said blade and the first end of said handle; and
a clip affixed to the second end of said handle, said clip being further affixed to the end of the tang of said blade.
